(19) United States
(12) Patent Application Publication
(10) Pub. No.: US 2020/0240829 A1
(43) Pub. Date: Jul. 30, 2020

(54) SMART WEIGHING SCALE AND METHODS RELATED THERETO

(71) Applicant: Panasonic Intellectual Property Management Co., Ltd., Osaka (JP)

(72) Inventors: James Juzheng ZHANG, Singapore (SG); Vasileios VONIKAKIS, Singapore (SG); Ariel BECK, Singapore (SG); Chandra Suwandi WIJAYA, Singapore (SG)

(21) Appl. No.: 16/257,807

(22) Filed: Jan. 25, 2019

(51) Int. Cl. G01G 19/414; A47F 9/04; G06K 9/00

(52) U.S. Cl. CPC G01G 19/4144; G06K 9/00671; A47F 9/048

(57) ABSTRACT

The present disclosure relates to smart weighing scale and methods related thereto. According to a method, at least one image corresponding to each of one or more grocery items resting on a pressure sensing platform of the smart weighing scale is captured. Further, at least a range profile and a range-azimuth signature corresponding to each of the one or more grocery items are obtained from a radar. Further, each of the one or more grocery items is automatically identified based on the at least one image, the range profile, and the range-azimuth signature corresponding to the said grocery item.

### TECHNICAL FIELD

The present subject matter relates to a smart weighing scale and methods related thereto.

### BACKGROUND

With advent of technology, implementation of smart weighing scales can be seen in retail outlets, such as supermarkets and grocery stores. A smart weighing scale is a digital weighing scale that assists a customer in making purchase of items based on observed weight. More specifically, the smart weighing scale computes the prices of the items. For computation of the prices of the items, most of the smart weighing scales require manual intervention. As an example, when a customer places an item on a weighing station/platform of the smart weighing scale, a display unit of the smart weighing scale displays a plurality of items to the customer. The customer is then required to select the item, from among the number of items as depicted in a graphical user interface (GUI). Upon receiving the selection of the item from the customer, the price for the item is then displayed on the display unit. Accordingly, the customer then makes the payment for the item to complete the purchase.

As may be gathered from above, conventional smart weighing scales typically require the customer to manually select an item that he/she intends to purchase. At least a challenge associated with the manual-selection of items is that the customer may resort to fraudulent activities while purchasing the items. For instance, the customer may intentionally select an item on the display screen that has lesser price than the item he is actually purchasing. Such scenarios result in monetary losses for a vendor of the items.

Another challenge associated with the manual selection of the items is that a customer may not be trained to operate the smart weighing scale, for example, due to an unfriendly user interface of the smart weighing scale. In such cases, the customer may face difficulties in operating the smart weighing scale or may not be able to execute it all-together. For instance, owing to the unfriendly interface, the customer may not be able to select the correct category of the grocery item in a single attempt. As a result, the time associated with the purchase may increase. This may further result in a bad purchase experience for the customer. Therefore, while the customer faces the inconvenience, the vendor may lose out on the sale.

To address the above challenges, certain conventional smart weighing scales have tried implementing object identification systems along with cameras. However, in such conventional smart weighing scales, the operation of the object identification system is limited by lighting requirements of the camera and occlusions caused due to the items. Furthermore, the object identification system also does not facilitate accurate identification of materials and/or internal structures of the items. As a result, at-least identifying different types of same object remains difficult. For instance, the conventional object classification system is not able to identify with ease, different types of the same fruit. In an example, differentiating “peach” from “plum” remains an ardous-task for the conventional systems. As a result, the conventional systems often end up incorrectly labelling a fruit. In such a case, correct billing of the items may not happen and manual corrective measures are often required.

Moreover, a customer always prefers to buy fresh and ripe grocery items, for example, vegetables and fruits. However, conventional smart weighing scales do not provide any information about the ripeness levels of the items being purchased. Known methods of determining ripeness involve intruding the food items, and thus are not suitable for implementation in smart weighing scales.

### SUMMARY

This summary is provided to introduce a selection of concepts in a simplified format that is further described in the detailed description of the present disclosure. This summary is neither intended to identify key inventive concepts of the disclosure nor is it intended for determining the scope of the invention or disclosure.

One embodiment of the present disclosure provides a smart weighing scale. The smart weighing scale comprises a pressure sensing platform to support one or more grocery items placed thereon. The smart weighing scale further comprises a camera configured to capture at least one image corresponding to each of one or more grocery items. Further, the smart weighing scale comprises a radar configured to generate at least a range profile and a range-azimuth signature corresponding to each of the one or more grocery items. Furthermore, the smart weighing scale comprises a processor configured to automatically identify each of the one or more grocery items based on the at least one image, the range profile, and the range-azimuth signature corresponding to the said grocery item.

Another embodiment of the present disclosure provides a method implemented by a smart weighing scale. The method comprises capturing, using a camera, at least one image corresponding to each of one or more grocery items resting on a pressure sensing platform of a smart weighing scale. Further, the method comprises obtaining, from a radar, at least a range profile and a range-azimuth signature corresponding to each of the one or more grocery items. Further, the method comprises automatically identifying each of the one or more grocery items based on the at least one image, the range profile, and the range-azimuth signature corresponding to the said grocery item.

The objects and advantages of the embodiments will be realized and achieved at least by the elements, features, and combinations particularly pointed out in the claims. It is to be understood that both the foregoing general description and the following detailed description are representative and explanatory and are not restrictive of the invention, as claimed.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 illustrates an exemplary smart weighing scale, according to an embodiment of the present disclosure;

FIG. 2 illustrates a schematic of a block diagram illustrating components of the smart weighing scale, according to an embodiment of the present disclosure;

FIG. 3 illustrates an example system architecture of a smart weighing scale configured to automatically identify grocery items, according to an embodiment of the present disclosure;

FIG. 4 illustrates a method implemented by a smart weighing scale, according to an embodiment of the present disclosure.

The elements in the drawings are illustrated for simplicity and may not have been necessarily been drawn to scale. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having benefit of the description herein.

### DETAILED DESCRIPTION OF SOME EXAMPLE EMBODIMENTS

For the purpose of promoting an understanding of the principles of the present disclosure, reference will now be made to the embodiment illustrated in the drawings and specific language will be used to describe the same. It will be understood that no limitation of the scope of the present disclosure is thereby intended, such alterations and further modifications in the illustrated system, and such further applications of the principles of the present disclosure as illustrated therein being contemplated as would normally occur to one skilled in the art to which the present disclosure relates.

The foregoing general description and the following detailed description are explanatory of the present disclosure and are not intended to be restrictive thereof.

Reference throughout this specification to “an aspect”, “another aspect” or similar language means that a particular feature, structure, or characteristic described in connection with the embodiment is included in at least one embodiment of the present disclosure. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or subsystems or elements or structures or components proceeded by “comprises . . . a” does not, without more constraints, preclude the existence of other devices or other subsystems or other elements or other structures or other components or additional devices or additional subsystems or additional elements or additional structures or additional components.

Unless otherwise defined, all technical and scientific terms used herein have the same meaning as commonly understood by one of ordinary skill in the art to which this present disclosure belongs. The system, methods, and examples provided herein are illustrative only and not intended to be limiting.

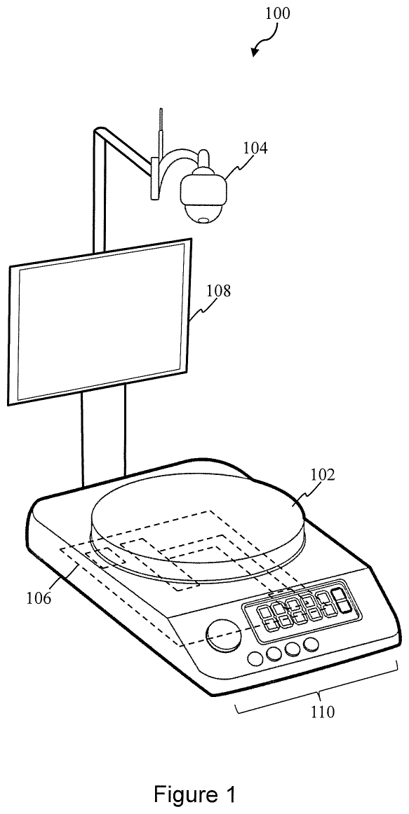

FIG. 1 illustrates an exemplary smart weighing scale 100, according to an embodiment of the present disclosure. The smart weighing scale 100 may be implemented in supermarkets, grocery stores, etc., for automatically identifying grocery items, such as fruits and vegetables, and determining prices thereof, according to an aspect of the present disclosure.

In an example embodiment, the smart weighing scale 100 comprises a pressure sensing platform 102. The pressure sensing platform 102 may be understood as a weighing station that serves as platform upon which one or more grocery items that an individual intends to purchase may be placed for evaluation. Further, the smart weighing scale 100 comprises a camera 104. The camera 104 is configured to capture images associated with the one or more grocery items.

Furthermore, the smart weighing scale 100 comprises a radar 106. The radar 106 is configured to generate various profiles and signatures associated with the one or more grocery items, as will be described in detail below. In an example, various parameters of the radar 106 may be configured as per example configuration 1 stated in the below table.

### Example Configuration 1

| Parameters | Settings |
|---|---|
| Start Frequency (Ghz) | 77 |
| Slope (MHz/us) | 77.96 |
| Samples per chip | 128 |
| Chirps per frame | 64 |
| Sampling rate (Msps) | 3.326 |
| Sweep Bandwidth (GHz) | 3 |
| Frame periodicity(msec) | 250 |
| Transmit Antennas (Tx) | 2 |
| Receive Antennas (Rx) | 4 |
| Range resolution (m) | 0.05 |
| Max Unambiguous Range (m) | 5.12 |
| Max Radial Velocity (m/s) | 8.96 |
| Radial Velocity Resolution (m/s) | 0.5597 |
| Azimuth Resolution (Deg) | 14.5 |
| numRangeBins | 128 |
| numDopplerBins | 32 |

Furthermore, the smart weighing scale 100 comprises a display unit 108 configured to display information related to the one or more grocery items and notifications to the individual. Furthermore, the smart weighing scale 100 may comprise a control interface 110 that may include control buttons for configuration and calibration of the smart weighing scale 100. The control interface 110 may also include control buttons to assist the individual in making the purchase. Additionally, the control interface 110 may also include a payment interface/unit for facilitating payment of the one or more grocery items.

In an embodiment, the camera 104 is configured to capture at least one image of each of the grocery items. Further, in said embodiment, the radar 106 is configured to generate a range profile and a range-azimuth signature for each of the grocery items. According to aspects of the present disclosure, each of the grocery items are then automatically identified using at least the range profile, the range-azimuth signature, and the at least one image corresponding to said grocery item. By implementing a system of the aforementioned type, i.e., the camera 104 and the radar 106, identification of the grocery items can be done with greater accuracy. For instance, the range profile and the range-azimuth signatures may be used in determining the material/composition of the chosen grocery items, and the image of the grocery item may be used for determining exterior features such as a color, a shape, and a texture of the grocery item. At least based on aforesaid, the grocery item can be identified and evaluated based thereupon with greater accuracy. Furthermore, a type of the grocery item may also be determined as a part of identification. Thus, aspects of the present subject matter provide for identification of different types of the same grocery item.

According to further aspects of the present disclosure, a price for each of the grocery items is computed and provided on the display 108 based on the identification and weighing. Furthermore, according to aspects of the present disclosure, a ripeness level of the grocery item may also be determined. At least based thereupon, a consumption-advisory or eating-guideline with respect to the grocery item may also be displayed on the display 108.

Details of the operation and working of the smart weighing scale 100 and components thereof is provided below.

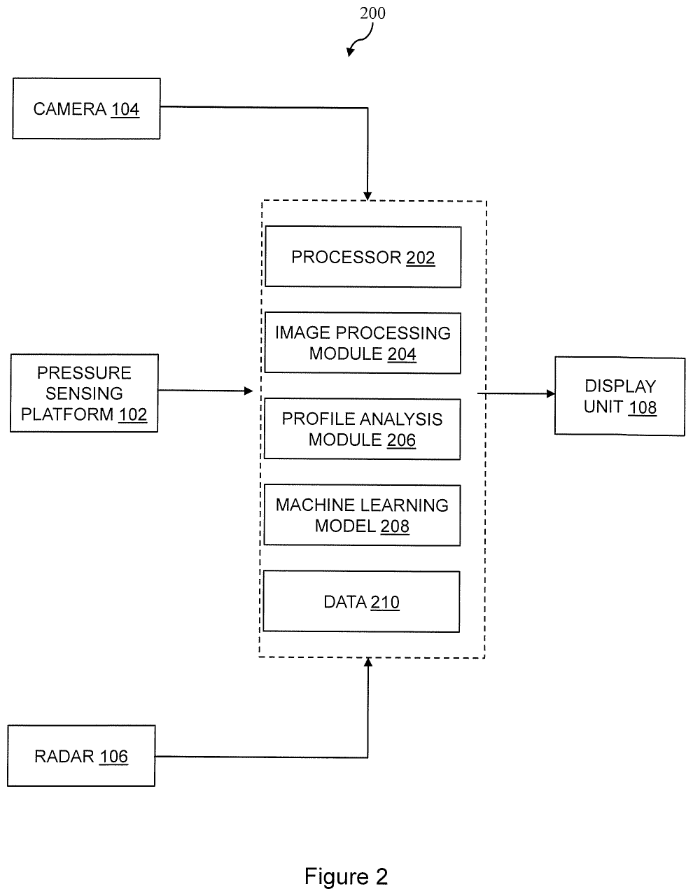

Referring to FIG. 2, a schematic block diagram 200 representing various components of the smart weighing scale 100, according to an embodiment of the present disclosure. Besides the components as mentioned in the description of FIG. 1, in an implementation, the smart weighing scale 100 comprises a processor 202, an image processing module 204, a profile analysis module 206, a machine learning model 208, and data 210.

The processor 202 can be a single processing unit or a number of units, all of which could include multiple computing units. The processor 202 may be implemented as one or more microprocessors, microcomputers, microcontrollers, digital signal processors, central processing units, graphical processing units, neural processing units, state machines, logic circuitries, and/or any devices that manipulate signals based on operational instructions.

In an example, the image processing module 204 and the profile analysis module 206, amongst other things, includes routines, programs, objects, components, data structures, etc., which perform particular tasks or implement data types. The image processing module 204 and the profile analysis module 206 may also be implemented as, signal processor(s), state machine(s), logic circuitries, and/or any other device or component that manipulate signals based on operational instructions. Further, the image processing module 204 and the profile analysis module 206 can be implemented in hardware, instructions executed by a processing unit, or by a combination thereof. The processing unit can comprise a computer, a processor, such as the processor 202, a state machine, a logic array or any other suitable devices capable of processing instructions. The processing unit can be a general-purpose processor which executes instructions to cause the general-purpose processor to perform the required tasks or, the processing unit can be dedicated to perform the required functions. In another aspect of the present subject matter, the image processing module 204 and the profile analysis module 206 may be machine-readable instructions (software) which, when executed by a processor/processing unit, perform any of the described functionalities.

In an example, an individual seeking to purchase one or more grocery items may place the grocery items upon the pressure sensing platform 102. Examples of the grocery items may include, but are not limited to, fruits and vegetables. Post placement of the grocery items on the pressure sensing platform 102, the smart weighing scale 100, at first, may ascertain whether the grocery items are correctly placed on the pressure sensing platform 102. In a non-limiting example, the correct placement of the grocery items may include placing the grocery items such that a base of each of the grocery items touches the pressure sensing platform 102. In another non-limiting example, the correct placement of the grocery items may include placing the grocery items such that each of the grocery items is within a peripheral boundary of the pressure sensing platform 102. In a non-limiting example, the incorrect placement of the grocery items may include placing the grocery items such that the grocery items are stacked together on top of each other, such that at least two grocery items overlap each other.

To this end, once the grocery items are placed on the pressure sensing platform 102, the pressure sensing platform 102 may transmit a signal indicating the placement of the grocery items thereon to the processor 202. Upon receiving the signal, the processor 202 may subsequently transmit a signal to the camera 104 to capture a group image of the grocery items. Upon receiving the signal, the camera 104 captures the group image of the one or more grocery items. In an implementation, the image processing module 204 is configured to determine an overlap percentage in the positions of at least two grocery items from the grocery items based on the group image. Once the overlap percentage is determined, the processor 202 then ascertains if the overlap percentage is greater than a predetermined overlap percentage or not. In a case where the overlap percentage in the positions of at least two grocery items is ascertained to be greater than the predetermined overlap percentage, the processor 202 is configured to display an item arrangement notification to the user through the display unit 108. The item arrangement notification may be understood as a message indicating or prompting the individual to correctly place the grocery items on the pressure sensing platform 102.

In a case where the overlap percentage in the positions of the at least two grocery item has been ascertained to be less than the predetermined overlap percentage, i.e., when the grocery items have been placed correctly, the smart weighing scale 102 automatically identifies each of the grocery items, as described below.

In an implementation, the image processing module 204 is configured to process the group image using one or more image processing techniques, and generate a segmented image. The segmented image may be understood as a version of the group image in which each of the grocery items in the group image is de-marked. In an example, the image processing module 204 stores the segmented image in the data 210.

In an implementation, the pressure sensing platform 102 is configured to generate pressure measurement data associated with the grocery items. The pressure measurement data includes a pressure heat-map corresponding to each of the grocery items. The pressure heat-map corresponding to a grocery item includes one or more pressure points corresponding to the grocery item. In an example, the pressure sensing platform 102 is configured to store the pressure measurement data in the data 210.

In an implementation, the processor 202 is configured to determine a weight of each of the grocery items based on the segmented image and the pressure measurement data. In said implementation, the processor 202 at first identifies a position of each of the grocery item based on the segmented image. Once the position of each of the grocery items is identified, the processor 202 is configured to generate one or more clusters corresponding to the one or more grocery items based on the position of each of the grocery items and the pressure measurement data. As an example, the processor 202 may identify the grocery items placed in vicinity to each other from the segmented image. Subsequently, the processor 202 analyzes the pressure heat-maps corresponding to the identified grocery items. In a case where the pressure-heat maps also indicate that the identified grocery items are in vicinity, the processor 202 is configured to form a cluster based on the identified like grocery items. Once the clusters are formed, the processor 202 determines a weight of each grocery item within the cluster based on the pressure-heat map corresponding to the grocery item. For instance, the processor 202 may correlate the pressure heat-map to the position of the grocery item and accordingly may determine the weight corresponding to the grocery item. Thus, the individual weights for all the grocery items are determined. Upon determining the individual weights of each of the grocery items, the processor 202 stores the same in the data 210 as weight measurement data.

In an implementation, the processor 202 is further configured to provide positioning signals to the camera 104 and the radar 106 to guide the camera 104 and the radar 106 to simultaneously focus on a selected grocery item from amongst the grocery items based on the position of the grocery item. As mentioned above, the processor 202 identifies the position of each of the grocery items based on the segmented image. Thus, for each of the grocery items, the processor 202 transmits a positioning signal to each of the camera 104 and the radar 106.

In an example, upon receiving the positioning signal corresponding to a grocery item, each of the camera 104 and the radar 106 focuses on the grocery item. In said example, the camera 104 is configured to capture at least one image corresponding to the grocery item. The at least one image is stored in the data 210 as image data, and is mapped to a position of the grocery item. In a similar manner, the radar 106 is configured to generate at least a range profile and a range-azimuth signature corresponding to the grocery item. The range profile and the range-azimuth signature corresponding to the grocery item are stored as profile data in the data 210. Thus, as may be understood, the image data include at least one image for each of the grocery items and the profile data includes at least a range profile and a range-azimuth signature for each of the grocery items.

In an implementation, the image processing module 204 is configured to determine a color, a shape, and a texture for each of the grocery items based on the image data. In said implementation, the image processing module 204 analyzes the at last one image corresponding to a grocery item using one or more image processing techniques and subsequently determines the color, the shape, and the texture for said grocery item. The color, the shape, and the texture of each of the grocery items are stored as grocery item data in the data 210.

In an implementation, the profile analysis module 206 is configured to extract a set of features for each of the grocery items based on the range profile and the range-azimuth signature corresponding to said grocery item. An example table 1 illustrating the set of features extracted is illustrated below.

EXAMPLE TABLE 1

| Feature | Description | Shape | Note |
|---|---|---|---|
| Maximum of | At each frame, the maximum | (num_frames, 1) | The Absolute Range Samples |
| the Absolute | value of the Absolute Range | | is calculated by taking the |
| Range Samples | Samples over the first 25 | | absolute value of the first |
| | bins is taken | | 25 bins of the range profile |
| Minimum of the | At each frame, the minmum | (num_frames, 1) | |
| Absolute Range | value of the Absolute Range | | |
| Samples | Samples over the first 25 | | |
| | bins is taken | | |
| Range of the | At each frame, the range | (num_frames, 1) | Range = Maximum − Minimum |
| Absolute Range | value of the Absolute Range | | |
| Samples | Samples over the first 25 | | |
| | bins is taken | | |
| Average of the | At each frame, the average | (num_frames, 1) | |
| Absolute Range | value of the Absolute Range | | |
| Samples | Samples over the first 25 | | |
| | bins is taken | | |
| Standard | At each frame, the standard | (num_frames, 1) | |
| Variance of the | variance of the Absolute | | |
| Absolute Range | Range Samples over the first | | |
| Samples | 25 bins is taken | | |
| Skew of the | At each frame, the skew of | (num_frames, 1) | |
| Absolute Range | the Absolute Range Samples | | |
| Samples | over the first 25 bins is taken | | |
| Kurtosis of the | At each frame, the kurtosis | (num_frames, 1) | |
| Absolute Range | of the Absolute Range | | |
| Samples | Samples over the first 25 | | |
| | bins is taken | | |
| Peaks of the | At each frame, the number of | (num_frames, 2) | At point is a peak if it is |
| Absolute Range | peaks and the average peak | | larger than its two neighbours |
| Samples | values of the Absolute Range | | |
| | Samples over the first 25 | | |
| | bins are taken | | |
| Histogram of | At each frame, the histogram | (num_frames, | num_histogram_bins1 = 10 |
| the Average | of the Absolute Range | num_histogram_bins1) | |
| Range Samples | Samples over the first 25 | | |
| | bins within the value range | | |
| | of [0, 15] is taken | | |
| Maximum of | At each frame, the maximum | (num_frames, 1) | ROI Region is set to be 20 × 20 |
| the Interested | of the ROI region of the | | |
| Range-Azimuth | Range-Azimuth heat-map is | | |
| Sample | taken | | |
| Mean of the | At each frame, the mean of | (num_frames, 1) | |
| Interested | the ROI region of the Range- | | |
| Range-Azimuth | Azimuth heat-map is taken | | |
| Sample | | | |
| Area of the | At each frame, the areas of | (num_frames, 1) | |
| Interested | the ROI region of the Range- | | |
| Range-Azimuth | Azimuth heatmap which are | | |
| Sample | larger than the Mean of the | | |
| | Interested Range-Azimuth | | |
| | Sample are taken | | |
| Histogram of | At each frame, histogram of | (num_frames, | num_histogram_bins2 = 50 |
| Interested | the ROI region of the Range- | num_histogram_bins2) | |
| Range-Azimuth | Azimuth heat-map within the value | | |
| Sample | range of [0, 2000] is taken | | |
| Local Binary | At each frame, the local | (num_frames, | ROI_Size = 20 * 20 = 400 |
| Feature of the | binary feature of the ROI | ROI_Size) | |
| Interested | region of the Range-Azimuth | | |
| Range-Azimuth | heat-map is taken | | |
| Sample | | | |

As mentioned above, the aforementioned set of features are extracted based on the range profile and the range-azimuth signature. Post extraction, in an example, the profile analysis module 206 classifies the set of features using a classifier, for example, a random forest classifier. Subsequently, the set of features and data generated post classification is stored in the data 210 as the profile data.

In an implementation, the processor 202 is configured to automatically identify each of the one or more grocery items based on the at least one image, the range profile, and the range-azimuth signature corresponding to the said grocery item. In said example, the processor 202 provides the at least one image, the range profile, the range-azimuth signature, the pressure heat-map, and the weight corresponding to each of the one or more grocery items as an input to the machine learning model 208.

Further, the machine learning model 208 also contributes to identification of said grocery item based on the at least one image, the range profile, the range-azimuth signature, the pressure heat-map, and the weight corresponding to the said grocery item. In an example, the machine learning model 208 accesses the already logged different type of data, i.e., the image data, the profile data, the weight measurement data, and the grocery item data, stored in the data 210 with respect to historically done identifications of the grocery items. For instance, based on the historically collected grocery item data, the machine learning model 208 may learn about the color, the shape, and the texture of a particular grocery item. Similarly, based on the historical profile data, the machine learning model 208 may learn about the set of features and post classification information associated with said grocery item. Thus, the machine learning model 208 also operates simultaneously and verifies the identification of the grocery-items as done in real-time, and thereby helps in an accurate and fast identification.

Once the grocery items are identified, the processor 202 is configured to compute a price of each of the one or more grocery items. In an example, where the price of a grocery item is to be determined by weight, for example, in the case of watermelon, the processor 202 determines the price based on the type of the identified grocery item and the weight of the said grocery item. In another example, where the price of the grocery item is to be determined by quantity, for example in the case of bananas, the processor 202 is configured to determine a quantity of a grocery item in the one or more grocery items. Subsequently, the processor 202 is configured to compute a price of the first grocery item based on the quantity of the grocery item.

Furthermore, in an implementation, the processor 202 is further configured to determine a grocery item ripeness level and a grocery item eating suggestion corresponding to each of the one or more grocery items based on a type of the grocery item, the range-azimuth signature, the color, and the texture corresponding to the said grocery item. Once a grocery item is identified, in said example, the processor 202 may determine the ripeness level corresponding to the grocery item based on the range-azimuth signature, the color, and the texture corresponding to the said grocery item. In said example, the processor 202 may implement a regression technique for determining the ripeness level corresponding to the grocery item. Subsequently, once the ripeness level is determined, the processor 202 is configured to determine the grocery item eating suggestion corresponding to the grocery item based on the type of the grocery item and the ripeness level.

In an implementation, post computation of the prices of the grocery items, the processor 202 is configured to display the names of the grocery items and their corresponding prices on the display unit 108. In an example, in addition to the prices, the processor 202 may also display the grocery item eating advisory corresponding to each of the grocery items on the display unit 108.

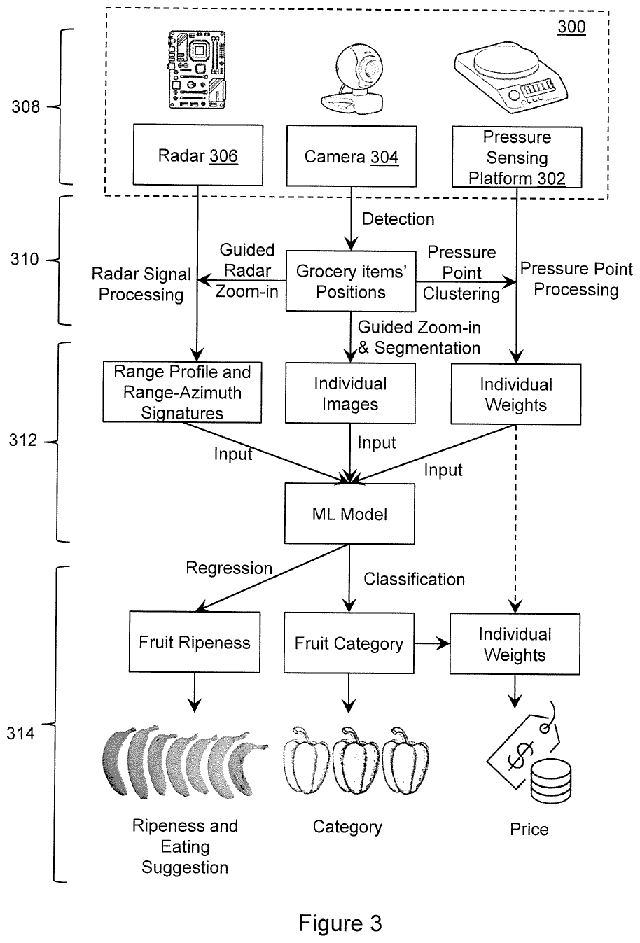

FIG. 3 illustrates an example system architecture of a smart weighing scale 300 configured to automatically identify grocery items, according to an embodiment of the present subject matter. As shown in the figure, the smart weighing scale 300 comprises a pressure sensing platform 302, a camera 304, and a radar 306. The working of the pressure sensing platform 302, the camera 304, and the radar 306 is explained below.

In an example, at step 308, one or more grocery items may be placed upon the pressure sensing platform 302. Once the grocery items are placed, the camera 304 may capture a group image based on which, the positions of the grocery items is determined.

At step 310, the positions of the grocery items are used for pressure point clustering and pressure point processing. Furthermore, the positions of the grocery items are used for guiding the camera 304 and the radar 306 to simultaneously focus on a grocery item. Post focusing, the camera 304 captures individual images of the grocery items and the radar generates a range profile and a range-azimuth signature for the grocery item. Furthermore, a weight of the grocery item is also determined. As may be understood, individual images, range profiles, range-azimuth signatures, and weights of all the grocery items are determined.

As a next step, at 312, for each of the grocery item, corresponding images, range profile, range-azimuth signature, and weight are fed into the machine learning model. At 314, the machine learning model performs a classification or identification of each of the grocery item based on the images, the range profile, the range-azimuth signature, and the weight corresponding to the said grocery item and historically done computations. Furthermore, the prices of each of the grocery items are also determined. Furthermore, the machine learning model, in an example, implements regression technique to determine the ripeness levels for each of the grocery items. In implementing regression technique to determine the ripeness levels, for example, these features can be used: item type, size, color, texture, weight or radar signatures for each of the grocery items.

In an example, a list of the grocery items and prices corresponding to the grocery items may be displayed on a display unit (not shown in the figure). Additionally, in an example, a grocery item ripeness level and a grocery item eating suggestion corresponding to each of the grocery items may also be displayed along with the prices.

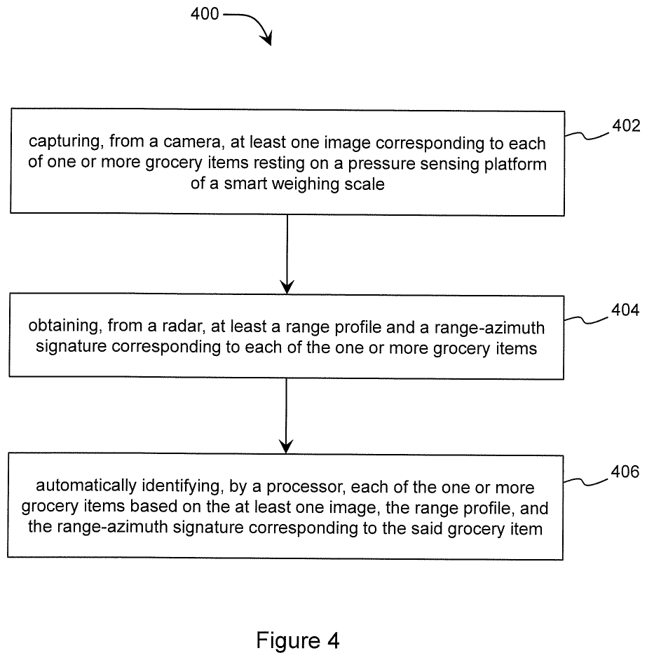

FIG. 4 illustrates a method 400, according to an embodiment of the present disclosure. The method 400 may be implemented in the smart weighing scale 100 using components thereof, as described above. Further, for the sake of brevity, details of the present subject matter that are explained in detail with reference to description of FIG. 2 above are not explained in detail herein.

At step 402, at least one image corresponding to each of one or more grocery items resting on a pressure sensing platform of a smart weighing scale is captured using a camera. In an example, an individual seeking to purchase the grocery items may place the grocery items on the pressure sending platform of the smart weighing scale. Post placement of the grocery items, at first, the smart weighing scale may ascertain whether the grocery items are correctly placed on the pressure sensing platform. In an example, where the grocery items are not placed correctly on the pressure sensing platform, an item arrangement notification is provided to the individual through a display unit of the radar.

When it is ascertained that the grocery items are placed correctly, the smart weighing scale may operate to automatically determine the prices of the grocery items.

During operation, a group image of the grocery items is captured. Based on the group image and pressure measurement data associated with the grocery items, individual weights of each of the grocery items is determined, as explained above.

Post determination of the weights, the at least one image corresponding to each of the grocery items is captured by the camera. In an example, based on the at least one image, a color, a shape, and a texture of each of the grocery items may be determined. In an example, the camera 104 may capture the at least one image corresponding to each of the grocery items.

At step 404, at least a range profile and a range-azimuth signature corresponding to each of the one or more grocery items is obtained from a radar. As explained above, a set of features for each of the grocery items is extracted based on the range profile and the range-azimuth signature. The set of features are subsequently classified using a classifier and are used in identification of the grocery items.

In an example, the radar 106 may generate and transmit the range profile and the range-azimuth signature for each of the grocery items.

In an example, both the camera and the radar receive positioning signal to simultaneously focus on a grocery item from the grocery items based on a position of the said grocery item.

At step 406, each of the one or more grocery items are automatically identified based on the at least one image, the range profile, and the range-azimuth signature corresponding to the said grocery item. In an example, the at least one image, the range profile, and the range-azimuth signature, and the individual weight of each of the grocery items is fed into a machine learning model. Post processing, the machine learning model provides as an output, a price for each of the grocery items that is subsequently displayed to the individual. In an example, based on a type of the grocery item, the price of the grocery item may be determined based on either the quantity of the grocery item or a quantity of the grocery item, as explained above. For example, the price of a grocery item, such as a banana may be based on a quantity of the banana. Whereas, the price of a grocery item, such as a watermelon may be based on a weight of the watermelon. Furthermore, in an example, along with the price, a grocery item ripeness level and a grocery item eating suggestion for each of the grocery item is also determined and displayed along with the price of the grocery items.

Terms used in this disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation, no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description of embodiments, claims, or drawings, should be understood to contemplate the possibilities of including one of the terms, either of the terms or both terms. For example, the phrase “A or B” should be understood to include the possibilities of “A” or “B” or “A and B.”

All examples and conditional language recited in this disclosure are intended for pedagogical objects to aid the reader in understanding the invention and the concepts contributed by the inventor to furthering the art and are to be construed as being without limitation to such specifically recited examples and conditions. Although embodiments of the present disclosure have been described in detail, it should be understood that various changes, substitutions, and alterations could be made thereto without departing from the spirit and scope of the present disclosure.

1. A smart weighing scale comprising:
a pressure sensing platform to support one or more grocery items placed thereon;
a camera configured to capture at least one image corresponding to each of one or more grocery items;
a radar configured to generate at least a range profile and a range-azimuth signature corresponding to each of the one or more grocery items; and
a processor configured to automatically identify each of the one or more grocery items based on the at least one image, the range profile, and the range-azimuth signature corresponding to the said grocery item.

2. The smart weighing scale as claimed in claim 1, wherein:
the camera is further configured to capture a group image of the one or more grocery items;
the pressure sensing platform is configured to generate pressure measurement data associated with the one or more grocery items, wherein the pressure measurement data comprises a pressure heat-map corresponding to each of the one or more grocery items, wherein the pressure heat-map comprises one or more pressure points corresponding to the said grocery item; and
the processor is further configured to:
identify a position of each of the one or more grocery items based on the group image;
determine one or more clusters corresponding to the one or more grocery items based on the position of each of the one or more grocery items and the pressure measurement data; and
determine a weight of each grocery item within a cluster based on the pressure heat-map corresponding to the said grocery item.

3. The smart weighing scale as claimed in claim 2, wherein the processor is further configured to compute a price of each of the one or more grocery items based on the identified grocery item and the weight of the said grocery item.

4. The smart weighing scale as claimed in claim 2, wherein the processor is further configured to:
provide the at least one image, the range profile, the range-azimuth signature, the pressure heat-map, and the weight corresponding to each of the one or more grocery items as an input to a machine learning model; and
identify, using the machine learning model, said grocery item based on the at least one image, the range profile, the range-azimuth signature, the pressure heat-map, and the weight corresponding to the said grocery item.

5. The smart weighing scale as claimed in claim 4, wherein the processor is further configured to determine a grocery item ripeness level and a grocery item eating suggestion corresponding to each of the one or more grocery items based on a type of the grocery item, the range-azimuth signature, the color, and the texture corresponding to the said grocery item.

6. The smart weighing scale as claimed in claim 1, further comprising an image processing module configured to determine a color, a shape, and a texture of said grocery item based on the at least one image.

7. The smart weighing scale as claimed in claim 1, wherein the processor is further configured to provide positioning signals to the camera and the radar to guide the camera and the radar to simultaneously focus on a selected grocery item from amongst the one or more grocery items based on the position of the grocery item.

8. The smart weighing scale as claimed in claim 1, wherein the processor is further configured to:
determine a quantity of a grocery item in the one or more grocery items; and
compute a price of the first grocery item based on the quantity of the grocery item.

9. The smart weighing scale as claimed in claim 1, further comprising a profile analysis module to extract a set of features for each of the one or more grocery items based on the range profile and the range-azimuth signature corresponding to said grocery item.

10. A method implemented by a smart weighing scale, the method comprising:
capturing, using a camera, at least one image corresponding to each of one or more grocery items resting on a pressure sensing platform of the smart weighing scale;
obtaining, from a radar, at least a range profile and a range-azimuth signature corresponding to each of the one or more grocery items; and
automatically identifying, by a processor, each of the one or more grocery items based on the at least one image, the range profile, and the range-azimuth signature corresponding to the said grocery item.

11. The method as claimed in claim 10, further comprising:
capturing a group image of the one or more grocery items;
identifying a position of each of the one or more grocery items based on the group image;
obtaining pressure measurement data associated with the one or more grocery items, wherein the pressure measurement data comprises a pressure heat-map corresponding to each of the one or more grocery items, wherein the pressure heat-map comprises one or more pressure points corresponding to the said grocery item;
determining one or more clusters corresponding to the one or more grocery items based on the position of each of the one or more grocery items and the pressure measurement data; and
determining a weight of each grocery item within a cluster based on the pressure heat-map corresponding to the said grocery item.

12. The method as claimed in claim 11, further comprising computing a price of each of the one or more grocery items based on the identified grocery item and the weight of the said grocery item.

13. The method as claimed in claim 11, wherein the automatically identifying each of the one or more grocery item further comprising:
providing the at least one image, the range profile, the range-azimuth signature, the pressure heat-map, and the weight corresponding to each of the one or more grocery items as an input to a machine learning model; and
identifying, by the machine learning model, said grocery item based on the at least one image, the range profile, the range-azimuth signature, the pressure heat-map, and the weight corresponding to the said grocery item.

14. The method as claimed in claim 13, further comprising determining a grocery item ripeness level and a grocery item eating suggestion corresponding to each of the one or more grocery items based on a type of the grocery item, the range profile, the range-azimuth signature, the color, and the texture corresponding to the said grocery item.

15. The method as claimed in claim 13, further comprising determining, by an image processing module, a color, a shape, and a texture of said food item based on the at least one image.

16. The method as claimed in claim 10, further comprising providing positioning signals to the camera and the radar to guide the camera and the radar to simultaneously focus on a selected grocery item from amongst the one or more grocery items based on the position of the grocery item.

17. The method as claimed in claim 10, further comprising:
determining a quantity of a grocery item in the one or more grocery items; and
computing a price of the grocery item based on the quantity of the grocery item.

18. The method as claimed in claim 11, further comprising:
determining, based on the group image, an overlap percentage in the positions of at least two grocery items from the one or more grocery items to be greater than a predetermined overlap percentage; and
displaying an item arrangement notification when the overlap in positions of the at least two grocery items is determined to be greater than the predetermined overlap percentage.

19. The method as claimed in claim 10, further comprising extracting, by a profile analysis module, a set of features for each of the one or more grocery items based on the range profile and the range-azimuth signature corresponding to said grocery item.

20. A non-transitory computer-readable medium having embodied thereon a computer program for executing a method implementable by a smart weighing scale, the method comprising:
capturing, using a camera, at least one image corresponding to each of one or more grocery items resting on a pressure sensing platform of the smart weighing scale;
obtaining, from a radar, at least a range profile and a range-azimuth signature corresponding to each of the one or more grocery items; and
automatically identifying, by a processor, each of the one or more grocery items based on the at least one image, the range profile, and the range-azimuth signature corresponding to the said grocery item.
